(19) United States
(12) Patent Application Publication
(10) Pub. No.: US 2012/0000111 A1
(43) Pub. Date: Jan. 5, 2012

(54) Interchangeable fishing lure

(76) Inventor: Gary Griffin, Rockaway, NJ (US)

(21) Appl. No.: 12/803,668

(22) Filed: Jul. 1, 2010

(51) Int. Cl. A01K 85/00

(52) U.S. Cl. 43/42.09; 43/42.37

(57) ABSTRACT

An interchangeable fishing lure having a sinkable head portion attached to a fishing line at its top, an integral bolt extending downward from the bottom of the head portion and threaded into the top of a separate tail portion, with the bottom of the tail portion having a fish hook attached thereon. The bottom of the head portion and the top of the tail portion having matching flat surfaces which are fully engaged when the head portion and the tail portion are fully screwed together on the bolt which engagement prevents the head and the tail portions from accidentally loosening or separating, but it permits the fisherman to easily unscrew the tail portion and interchange it with a different tail portion to suit different species of fish and varying fishing conditions without having to also remove and reattach a different head portion head to the fishing line.

### FIELD OF THE INVENTION

The present invention relates to an interchangeable fishing lure in the general form of a fish or worm having a head portion which is attached at its top to a fishing line, the bottom of the head portion has an integral bolt centrally embedded therein which extends downward from the bottom of the head portion and into a matching threaded hole in the top section of a tail portion. The bottom section of the tail portion has a fish hook attached thereto and may also include different baits, colors and other attractions to fish.

The bottom section of the head portion and the top section of the tail portion have matching external flat surfaces which are compressed together when the head and tail portions are fully threaded tight on the bolt This provides a locking force which prevents the head and tail portions from accidentally loosening and separating. The fisherman can easily unthread and separate the head and tail portions so that another tail portion having different hooks, baits, colors, or other attractions to lure fish can be easily interchanged with threaded to the head portion at the choice of the fisherman to suit different fish and varying fishing conditions.

### BACKGROUND AND SUMMARY OF THE INVENTION

Fishing lures are present in almost an infinite variety of colors, baits, shapes, sizes, hooks and other attractions to suit the individual choices of a fisherman.

Fishermen have traditionally utilized a multiplicity of different fishing lures which they choose to attract and hook differing fish under differing conditions.

Heretofore, each of different lures must be individually attached to the fishing line, then detached, and another lure separately reattached thereto. This changing of lures is painstaking in that such changes of lures must be slowly and carefully done to avoid accidental hooking of the hands of the fisherman. It can also be too time consuming to meet rapid changes of kinds of fish or conditions of fishing.

It is an object of the present invention to provide an interchangeable fishing lure that can be attached, detached and reattached to a fishing line in an easy, quick and safe manner.

This and other objects and advantages of the present invention will become apparent to those skilled in the art from the following drawings and detailed description.

### BRIEF DESCRIPTION OF THE DRAWINGS

An interchangeable fishing lure of the present invention is depicted in the following drawings which form a part of this disclosure and wherein:

FIG. 1 is a schematic of a typical fisherman's tackle of a rod, a reel, a fishing line and a The interchangeable fishing lure;

FIG. 2 is an exploded and partially sectional view of the preferred embodiment of the interchangeable fishing lure;

FIG. 3 is an exploded and partially sectional view of an alternate embodiment of the interchangeable fishing lure; and

FIG. 4 is an exploded and partially sectional view of another embodiment of the interchangeable fishing lure.

### DETAILED DESCRIPTION

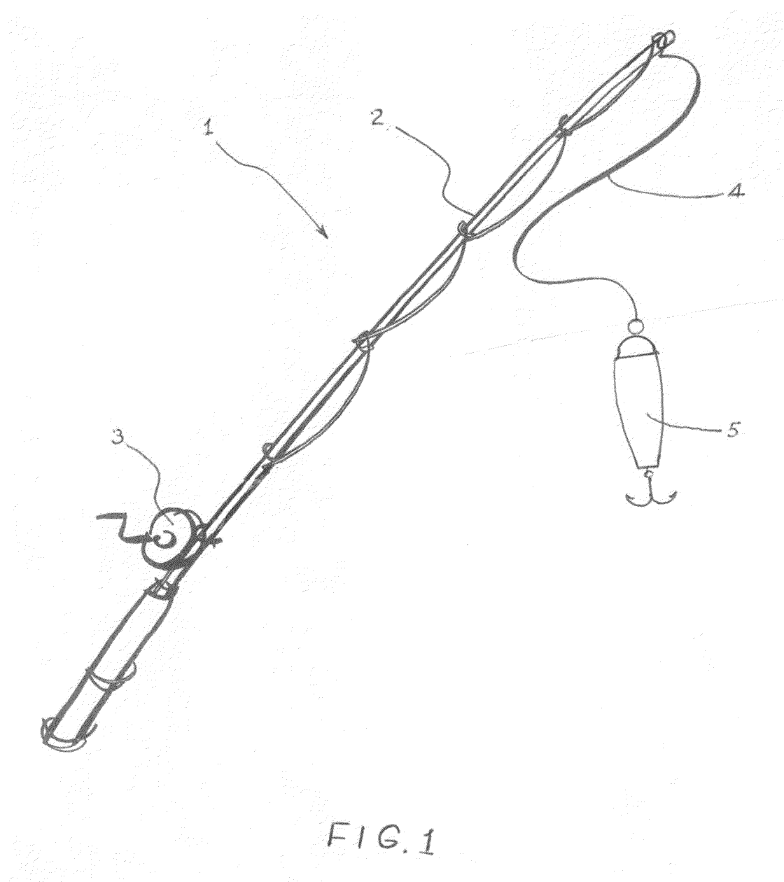

Referring to the above drawings by numerals of reference, there is shown in FIG. 1 a schematic of a typical fisherman's tackle, generally shown as 1 consisting of a fishing rod 2 with a reel 3 mounted thereon. A fishing line 4 is connected at one end to the reel 3 and is wound within and along the fishing rod 2 to the other end where it is connected to the interchangeable fishing lure 5 of the present invention.

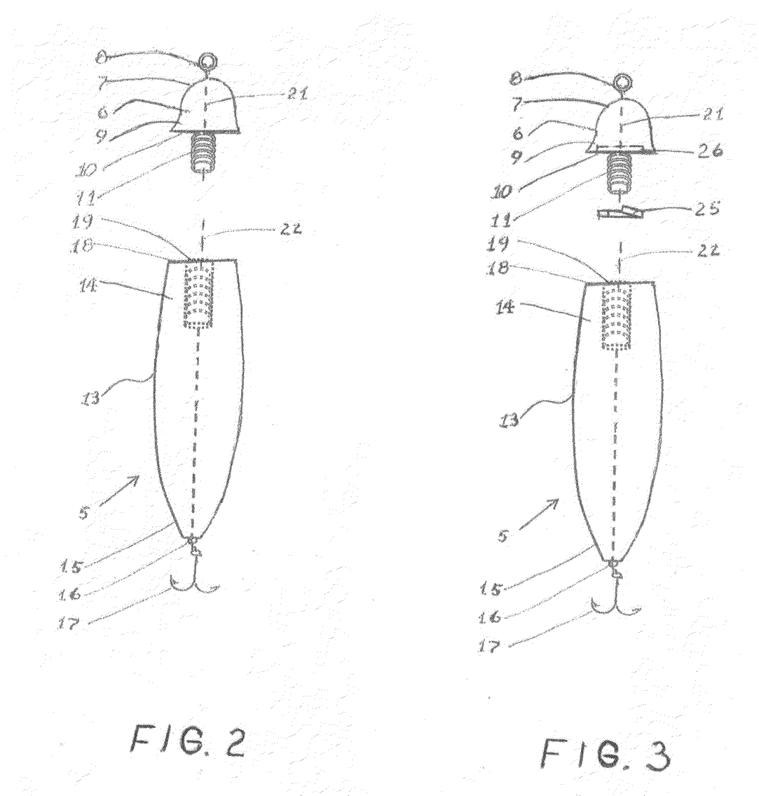

Referring now to FIG. 2 there is shown an exploded and partially sectional side view of the preferred embodiment of the interchangeable fishing lure 5 which has the general form of a fish or worm with a generally tapering circular cross-section. The interchangeable fishing lure 5 has a head portion 6 and a tail portion 13. The head portion 6 is preferably made of metal A top section 7 of the head portion 6 has an attachment 8, such as a ring or swivel, for connection by tying onto the fishing line 4. The bottom 9 of the head portion 6 has a flat bottom external surface 10 which is perpendicular to the axis 21 of the head portion 6. Extending downward from the flat bottom surface 10 along the axis 21 of the head portion 8 is an integral bolt made of metal or plastic. A separate tail portion 13 made of wood, or plastic or is located below the head portion 6. The top section 14 of the tail portion 13 has a flat external surface 18 perpendicular to the axis 22 of the tail portion 13 with a central threaded hole 19 therein extending downward along the axis 22 of the tail portion 13, which axis 22 is a straight continuation of axis 21 of the head portion 6. The flat bottom surface 10 of the head portion 6 and the top flat surface 18 of the tail portion 13 are joined together in close contact by screwing the integral bolt 11 into the threaded hole 10 of the tail portion 13. This joining together of the flat surfaces 10, 18 provides a locking force to lock the head portion 6 to the tail portion 13 so as to resist accidental loosening and separation of the tail portion 13 from the head portion 6. Extending downward from the top 14 of the tail portion 13 is a tail bottom section 15 having at least one steel lead 16 which has at least one steel fishhook 17 attached thereto. Onto the fishhook 17 the fisherman may attach varying baits or other attractions to lure fish. In the event that the species of fish or fishing conditions vary, the fisherman may easily and efficiently detach the tail portion 13 from the head portion 6 by manually unscrewing the tail portion 13 along the bolt 11 from the head portion 6 and interchanging the tail portion 13 with another tail portion 13 more suited to the species of fish or varying fishing conditions.

Referring now to FIG. 3 there is shown an alternative embodiment of the interchangeable fishing lure 5 of the present invention. FIG. 3 has all of the numeral elements of FIG. 2, and in addition thereto has a metal or plastic lock washer 25 encircling the integral bolt 11 at the bottom section 9 of the head portion 6. An annular groove 26 encircling the bolt 11 is positioned in the bottom surface 10 of the head portion 6. The groove is partially depressed above the bottom surface 10 of the head portion 6 so as to hold the lock washer 25 in a friction fit seat which prevents the lock washer 25 from falling away from the head portion 6 when separated from the tail portion 13 during interchange of fishing lures 5. The lock washer 25 provides additional locking force to prevent the accidental loosening and separation of the head portion 6 from the tail portion 13.

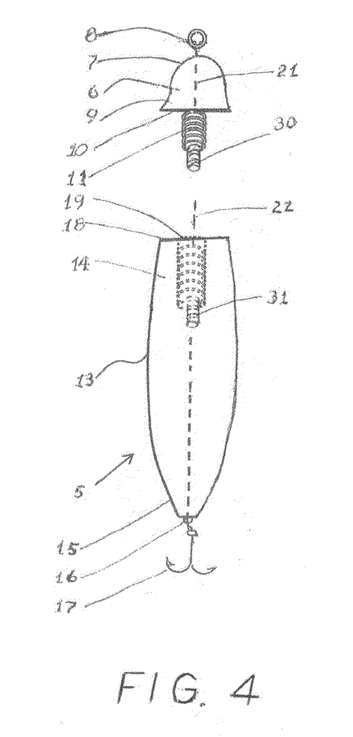

Referring now to FIG. 4 there is shown another alternative embodiment of the interchangeable fishing lure 5 of the present invention. FIG. 4 retains all of the numeral elements of FIG. 2 and, in addition thereto, has a reduced diameter threaded bolt extension 30 extending downward from the integral bolt 11 in the head portion 6. The central threaded hoe 19 of the tail portion 13 has a corresponding reduced diameter threaded hole extension 31 extending downward within the tail portion 13. The screwing together of the tail portion 13 onto the head portion 6 provides additional locking force by additional engagement of the bolt 11 and the bolt extension 30 with the corresponding central threaded hole 19 and threaded hole extension 31. This additional locking force further prevents accidental loosening and separation of the head portion 6 from the tail portion 13.

The present invention has been defined by the embodiments set forth above, but it should be understood that this is by way of illustration only and that the present invention is not necessarily limited thereto. Modifications and variations will be apparent from the athe disclosure without departing from the present invention as those skilled in the art will readily understand. Accordingly, such modifications and variations of the disclosed present invention are considered to be within the purview and scope of the present invention and the following claims.

1. An interchangeable fishing lure in the shape of a fish or worm with a generally circular cross section comprising:
a sinkable head portion with a top section attached to a fishing line, and a bottom section having a head flat surface perpendicular to the axis of the head portion;
a threaded bolt extending downward from the center of the head flat surface along the axis of the head portion;
a tail portion having a top section with an external tail flat surface perpendicular to the axis of the tail portion;
a threaded hole extending downward from the center of the external tail flat surface along the axis of the tail portion; and
a bottom section of the tail portion having a at least one lead extending outside the tail portion with at least one fishhook attached to the lead, whereby the head portion and the tail portion are locked together when the threaded bolt and the threaded hole are screwed together with the external flat surfaces in matching contact, and the tail portion can easily and efficiently be screwed apart from the head portion by the fisherman's hands and the tail portion can be interchanged with a different tail portion to suit different species of fish or varying fishing conditions without the necessity of the fisherman also having to remove the head portion from the fishing line.

2. The interchangeable fishing lure of claim 1 which additionally comprises:
a lock washer encircling the bolt so that when the head portion and the tail portion are screwed together the lock washer provides additional locking force to prevent the tail portion from loosening or separating from the head portion.

2. The interchangeable fishing lure of claim 1 which additionally comprises:
A reduced diameter threaded bolt extension bolt extension extending downward downward from the integral bolt in the head portion; and
a reduced diameter threaded hole extension extending downward from the threaded hole in the tail portion so that when the head portion and the tail portion are screwed together the reduced diameter threaded bolt extension and the reduced diameter threaded hole extension provide additional locking force to prevent the tail portion from loosening or separating from the head portion.

3. The interchangeable fishing lure of claim 1 wherein the head portion is made of metal.

4. The interchangeable fishing lure of claim 1 wherein the tail portion is made of plastic.

5. The interchangeable fishing lure of claim 1 wherein the tail portion also includes a multiplicity of fishhooks, colors, or other attractions to lure fish.
